(19) United States
(12) Patent Application Publication
(10) Pub. No.: US 2009/0126029 A1
(43) Pub. Date: May 14, 2009

(54) Permanent Data Hardware Integrity

(75) Inventors: Olivier Benoit, Carnoux En Provence (FR); Mickael Tunstall, Marseille (FR); Khanh Quoc Nguyen, Singapore (SG)

Correspondence Address: BUCHANAN, INGERSOLL & ROONEY PC, POST OFFICE BOX 1404, ALEXANDRIA, VA, 22313-1404, US

(73) Assignee: Avenue du Pic de Bertagne, Parc d'Activite de Gemplus, Gemenos (FR)

(21) Appl. No.: 11/989,122

(22) PCT Filed: Jul. 19, 2006
(86) PCT No.: PCT/EP2006/064425

§ 371 Date: Jul. 17, 2008

(30) Foreign Application Priority Data
Jul. 19, 2005 (FR) 0552237

(51) Int. Cl. G06F 21/02

(52) U.S. Cl. 726/34

(57) ABSTRACT

A method for processing digital data X of an item of software coded on lₓ bits, for detecting faults in an electronic circuit comprising at least one bus, a processing unit, a memory for running the software, and a hardware architecture. The digital data X is transformed into digital data Z coded on lₓ+l_{y} bits, the additional l_{y} bits being the result of an integrity function f applied to the data X. The digital data Z is processed by the set of hardware resources of the circuit, these hardware resources working on words of lₓ+l_{y} bits. The integrity of data Z is verified during the processing step.

The present invention relates to the field of making data secure in an electronic component.

The present invention relates more particularly to a method and to an architecture for protecting a hardware integrated circuit against fault attack.

Smart cards, and more generally certain portable electronic components, are often used as units for computing and storing secret and/or sensitive data with the aim of making an application secure. Identity, mobile telephones, payment, transport, or indeed access control are all fields of application in which the smart card has an essential role to play.

That role consists, inter alia and non-limitingly, in authenticating the holder of the card and/or the issuer of the card. The card can also contain “units” that can correspond to loyalty points, money (e.g. telephone units), or indeed subway tickets, depending on the application.

The smart card thus represents, for certain dishonest individuals and organizations, a target of predilection for acting fraudulently or for damaging the brand image of a company.

Since being deployed, smart cards have had to deal with threats from power or current consumption observation (side channel analysis) and, more recently, from attacks by injecting transient faults. Such attacks are relatively complex to detect, and it is difficult to implement responses to such attacks. Currently, electronic components do not guarantee correct operation regardless of the external disturbances. As a result, the software embedded in the card must protect itself from any component failure generated by injecting a fault.

Solutions are already known from the prior art for detecting disturbances, e.g. glitches (voltage spikes), that might give rise to a fault in operation of the electronic component. It should be noted that hardware solutions exists that consist in integrating environmental sensors (for sensing temperature, clock frequency, power supply voltage, or light) that detect a disturbance (a voltage that is abnormally low, a light intensity that is too high) in order to react before the component enters an operating zone deemed to be unstable and thus risky in terms of faults. Those solutions are costly because they require specific sensors to be developed (economic cost) and such sensors to be integrated into circuits that are sometimes very small in size (sizing cost).

Solutions are also known that detect the effect of the disturbance suffered, e.g. by the presence of a modified data bit.

Among others, there exist software or hardware solutions of the type providing redundancy for a process. The redundancy consists simplistically in performing the same operation (computation, transmission, etc.) twice in order to compare the results of the two actions. In software mode, the redundancy can be a double computation on data. In hardware mode, this redundancy can be manifested by the presence, for example, of two duplicate registers that store, a priori, the same values. If the results are different, then it can reasonably be concluded that one of the actions did not take place properly, probably consequent upon a disturbance (fault). The drawback with those solutions lies in the fact that the protection or detection is provided at a point only, and in the fact that performance is lost due to operations being repeated. Redundancy offers a guarantee only for the operation that is performed in duplicate.

Software or hardware solutions also exist that are of the integrity check type. An item of data stored in a non-volatile memory has a checksum added to it, that checksum making it possible to detect whether the data is corrupted by a fault and then to verify the checksum in the event of inconsistency between the data and the checksum. Adding integrity data is in widespread use in software layers, e.g. for transmitting data. Hardware checksums, as found in the prior art, are implemented only at memory block level, and are often referred to as “parity bits”. The elementary machine word (8 bits on an 8-bit component) is stored on 9 bits in the memory, the 9^{th} bit being a parity bit positioned such that the parity of the word is systematically even/odd. On reading, the parity is verified and the 8-bit word is positioned on the data bus. On writing, the 8-bit world positioned on the data bus is written in the memory and the parity bit is generated at the same time. The problem is that, on the data bus, the transmitted word does not include any integrity data: there is no way of verifying that that value, once transferred to the memory, to the central processing unit (CPU), or to the cache, is still correct.

It should be noted that, with concern for optimum security, the ideal situation would be to be able to detect a fault regardless of the effect thereof. Unfortunately, that is not possible at a reasonable cost with the above-described prior art systems (redundancy, and checksum).

Generally, the prior art solutions do not make it possible to perform integrity checking permanently on the data. No solution is proposed for permanent integrity checking of data at hardware level.

A need therefore exists for faults to be detected systematically and for permanent integrity of data to be guaranteed during manipulations by the hardware elements.

An object of the present invention is to remedy the drawbacks of the prior art by proposing a method of processing data for detecting faults, and a hardware architecture that is also provided for that purpose. The method and the architecture make it possible to work on words including integrity data systematically; the number of bits of the words is greater than the number l_{X} of initial data items X so as to incorporate integrity functionalities Y permanently into all of the hardware processing steps.

The method of the present invention satisfies particularly well the needs for fault detection because it guarantees integrity for the data throughout the processing chain, and throughout the life of the data, while also maintaining processing performance.

Each hardware component is designed to work systematically with l_{X}+l_{Y} bits in order to make detection optimal and systematic. This means that each software word X is stored in a memory in l_{X}+l_{Y} cells, and that the software word X is transferred from one hardware module to another with its associated checksum on a bus of l_{X}+l_{Y} lines. In this way, the software word is protected regardless of its type: address, data, instruction, operand, etc.

To this end, in its most general acceptation, the invention provides a method of processing digital data X of software that is coded on a number l_{X} of bits for detecting faults in an electronic circuit comprising at least a bus, a processor unit, and a memory for executing the software, the method comprising:
a transformation step for transforming the digital data X into digital data items Z that are coded on a total number of l_{X}+l_{Y} bits, the l_{Y} additional bits being the result of an integrity function f applied to said data X;
a processing step for processing the digital data Z by the entire set of the hardware resources of the circuit, the hardware resources working on words of l_{X}+l_{Y} bits; and
at least one integrity verification step for verifying the integrity of said data Z during said processing step.

In an implementation, said data Z consists in the concatenation of the data X with the integrity data Y resulting from the integrity function f applied to the data X: Z=X|Y=X|f(X). Below “|” is the operation indicating concatenation of two elements (X and Y in the above).

In another implementation, said integrity function f computes the number of bits set to “1” or to “0” in said digital data X.

More particularly, said processing step for processing the digital data Z is performed by an arithmetic and logic unit (ALU), and comprises:
a computation step for computing an operation OP on the data X of the data Z; and
a computation step for computing said operation OP on the additional integrity bits of said data Z;

and said integrity function f complies with the following:

f(X₁OPX₂)=f(X₁)OPf(X₂).

In an implementation, said processing step for processing the digital data Z is performed by an arithmetic and logic unit (ALU), and comprises:
a first step for checking the integrity of the data Z;
a following step for computing an operation OP on the data X of the digital data Z; and
a step for transforming the digital data resulting from said operation OP into digital data Z′ coded on a total number of l_{X}+l_{Y} bits, the l_{Y} additional bits being the result of the integrity function f applied to said data items resulting from said operation OP.

Particularly, said function f is defined by f(X)=X/l_{X}, where: l_{X} is the length in number of bits of the binary word X.

The invention also provides a hardware architecture for detecting faults in an electronic circuit, the architecture comprising:
transformation means for transforming digital data items X of software that are coded on x bits into digital data items Z that are coded on l_{X}+l_{Y} bits, the l_{Y} additional bits being the result of an integrity function f applied to said data items X;
hardware resources comprising at least a bus, a processor unit, and a memory, for processing the digital data Z, the entire set of said hardware resources working on words of l_{X}+l_{Y} bits; and
means for verifying the integrity of said data Z during said processing step each time the data items X are manipulated.

In an embodiment, said bus is provided with at least one means for verifying the integrity of said data Z transferred by said bus.

In a particular embodiment, said hardware resources comprise at least a memory that stores said data Z in the form of words of size l_{X}+l_{Y} bits (size of the software word+size of the integrity check word).

In an embodiment, said hardware resources comprise at least at least registers associated with a central processing unit (CPU), said registers storing the data Z in the form of words of size l_{X}+l_{Y} bits, and said central processing unit (CPU) performing operations separately on said data X and on the additional integrity bits Y.

Particularly, said hardware resources comprise at least one arithmetic and logic unit (ALU) computing an operation OP separately on said data X of the data Z and on the additional integrity bits of the data Z, and said integrity function f complies with the following:

f(X₁OPX₂)=f(X₁)OPf(X₂).

Optionally, said material resources comprise at least one arithmetic and logic unit (ALU), said ALU:
comprising means for checking the integrity of said data Z;
computing an operation OP on the data X of the data Z; and
transforming the digital data items resulting from said operation OP into digital data items Z′ coded on l_{X}+l_{Y} bits, the l_{Y} additional bits being the result of the integrity function f applied to said data resulting from said operation OP.

In an implementation, said integrity function f computes the number of bits set to “1” or to “0” in said software word X, or said function f is defined by f(X)=X/l_{X}, where l_{X} is the length in bits of the binary word X.

The invention also provides an electronic component, e.g. a smart card, including one of the preceding hardware architectures.

The invention can be better understood from the following description of an embodiment of the invention, given merely by way of explanation and with reference to the accompanying figures, in which:

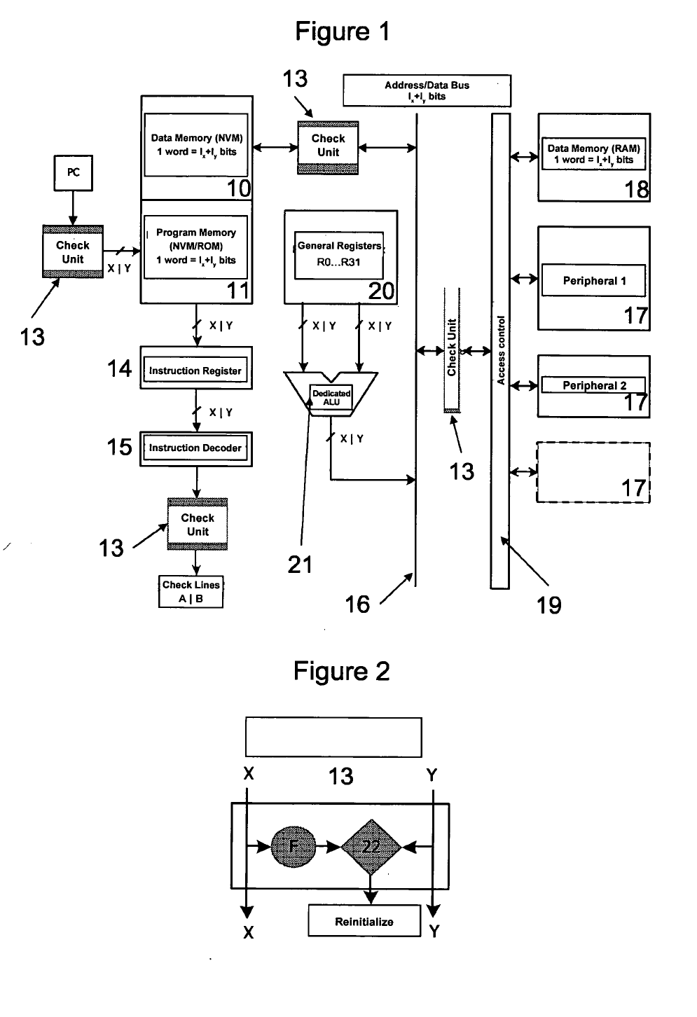

FIG. 1 is an overall diagram of an embodiment of a hardware architecture of the present invention;

FIG. 2 shows a check unit implemented in the architecture of FIG. 1;

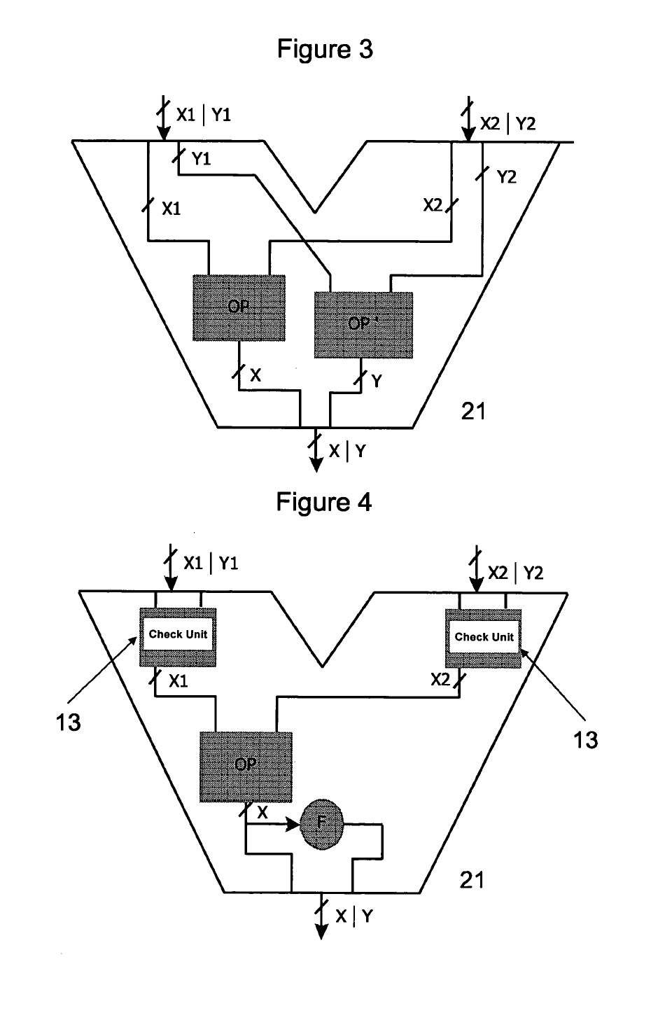

FIG. 3 shows an embodiment of a arithmetic and logic unit (ALU) that is transparent for the integrity function; and

FIG. 4 shows a less secure embodiment of an arithmetic and logic unit (ALU) in which the integrity information items are recomputed.

In the following description, the term “data” is used to mean any digital information that passes through or that is executed, stored, or processed in the integrated circuit, regardless of whether such data is constituted by binary variables, memory addresses, instructions, etc. In the invention, every item of data is assigned a checksum.

Similarly, the terms “checksum”, “parity bits”, “integrity bits/data” or indeed “check word” are considered to be synonyms and represent additional items of data in addition to an item of data, which additional items of data are determined as a function of the item of data, e.g. by a function. Such integrity data makes it possible to check the integrity of a file or of a block of data, and to verify with more or less precision whether data has been transmitted correctly. A conventional method is Cyclic Redundancy Checking (CRC).

The term “software word” is used to mean the binary succession representative of an item of data used by a piece of software, e.g. a variable, and considered as a whole for any particular processing. A software word can have a size of 8, 16, or 32 bits, for example. In the description below, the letter “X” represents such a software word and “l_{X}” represents the size of the software word.

The term “hardware word” or “machine word” is used to mean the binary succession used by the hardware elements of the electronic circuit to manipulate the software words during a software command. The electronic circuit comprises at least a data/address bus, a memory, and a processor unit (CPU, ALU, etc.). the machine words can have the same size as the software words but, in the present invention, they are of larger size, e.g. 10, 18, or 36 bits for software words of respectively 8, 16, or 32 bits. The additional or “overhead” bits are integrity bits for encoding a checksum that can be constituted by a single bit or by a plurality of bits in order to increase the probability of detecting a fault. In the description below, the letter “Z” designates the hardware word, and the letter “Y” designates the integrity bits, so that Z=X|Y; and “l_{z}” and “l_{Y}” designate the associated sizes.

The integrity data items Y are computed on the basis of the software word X by a function f referred to as an “integrity function” so that Y=f(X). An example of an integrity function f is the number of bits at “1” (at “0”) in the software word X.

The software word X on its own is considered to be unprotected because any inopportune modification of a bit of it cannot be detected. Conversely, in the machine word Z=X|Y, the software word X is protected because any modification of it implies inconsistency between the integrity data Y and the word X.

With reference to FIG. 1, an embodiment of an architecture for the electronic circuit of an electronic component is proposed. The hardware architecture presented is extended to hardware words including integrity data Y in addition to the software word X.

Regardless of the hardware path taken or of the storage, integrity data items are associated permanently with the software words.

The address and data buses are of size l_{X}+l_{Y}, the words in the memory use memory cells of size l_{X}+l_{Y}, and the central processing unit (CPU) uses registers and data items of size l_{X}+l_{Y}.

Storage memories of the Non-Volatile Memory (NVM) type or of the Read-Only Memory (ROM) type 10 and 11 store data and computer programs in the form of machine words of l_{X}+l_{Y} bits. These items of data are recorded from an external computer station 12 after the transmitted data items have been verified by an integrity check unit 13. The check unit 13 verifies that the data transmitted by the station 12 do not contain any inconsistency. With reference to FIG. 2, an embodiment of a check unit 13 is proposed. The check unit 13 receives as input a machine word made up of the software word X and of the integrity data items Y. The check unit knows the integrity function f. On the basis of X and of f, it computes the value of Y that is, a priori, expected. That value is then compared 22 with the value of Y received as input. The check unit 13 then transmits the data X and Y as output if the comparison is positive, the data X and Y then being considered to be mutually consistent.

Returning to FIG. 1, on execution of the program stored in the memory 11, an instruction, e.g. a bytecode, in the case of an interpreted language, is transmitted and then stored in an instruction register 14. The transmission and the storage are also implemented by working on the machine word X|Y. Then, an instruction decoder 15 interprets the instruction on the basis of the machine word(s) Z contained in the registers 14 and transmits the information to command lines after the integrity of the data has been verified again by a check unit 13.

Data items in the form of a machine word X|Y are also transmitted over a data/address bus 16 of l_{X}+l_{Y} bits. Thus, the data bus 16 conveys data protected by the integrity information. In order to compartmentalize each functional hardware structure (e.g. the read-only memory zone, the bus, and the Random Access Memory (RAM)), an integrity check unit 13 can be used for each link between two different functional hardware structures. This applies between the memory zone 10 and the data bus 16: the integrity of the data is checked prior to transmission over the bus and/or on reception from the bus.

Peripherals 17 and read/write memories of the RAM type 18 all working with machine words of size l_{X}+l_{Y} are also part of the architecture and they converse with the data bus 16 via an access control bus 19 and via a check unit 13.

General registers 20 are also available and they store data delivered, for example, by a central processing unit (CPU) in cells of size l_{X}+l_{Y}. These registers 20 feed an arithmetic and logic unit (ALU) 21 with data items X|Y. This ALU 21 works on hardware words X|Y and implements logic and/or arithmetic operations in order to deliver an item of data also on l_{X}+l_{Y} bits.

FIG. 3 shows an embodiment of an ALU 21 that is transparent to integrity data. The term “transparent” is used to express the fact that the ALU 21 considers the integrity data Y to be data items in their own right, independently of their status as integrity data. The arithmetic and logic unit is capable in full or in part of processing operations on X|Y in order never to have to recompute the integrity data Y on a software word X that is not protected.

The ALU 21 receives two hardware words as input: Z₁=X₁|Y₁ and Z₂=X₂|Y₂, and delivers one hardware word Z=X|Y as output. The ALU 21 performs an operation OP on the software words X₁ and X₂ in compliance with its own function, delivering one result word X=X₁ OP X₂. The integrity data items are processed similarly by an operation OP′: Y=Y₁ OP′ Y₂.

It should be noted that, in order to guarantee the integrity of the machine word Z output from the ALU 21, it is necessary for:

f(X₁OPX₂)=Y₁OP′Y₂=f(X₁)OP′f(X₂)

Each digital data item X is associated with an integrity data item Y, also referred to as a “redundancy check data item”. Each operation performed on the digital data item X is also associated with an integrity function or operation on the digital data item X.

Since the integrity verification and obtaining the resulting data at the end of the operation take place in parallel and/or consecutively, a fault attack effected at the level of any operation causes inconsistency between the resulting data obtained at the end of the operation and the corresponding integrity data obtained in parallel.

Thus, mere verification between the data obtained at the end of a predetermined operation and an integrity verification at the end of execution of the operation in question is sufficient for detecting the presence of a fault attack throughout and/or after execution of the operation.

In the following paragraphs, a known algorithm, namely the Montgomery modular multiplication algorithm, is taken as an example of an operation OP.

It should be recalled that operation of the hardware implementation is based on the difficulty of manipulating large integers, e.g. integers having a size of about 1024 bits.

Due to the nature of the Montgomery modular multiplication, verifying the integrity of the data obtained at the end of a Montgomery modular multiplication can be performed efficiently.

It should be recalled that a Montgomery modular multiplication, known to the person skilled in the art, for multiplying two integers x and y mod m, has as input the following three items of data (or operands), where the function “mod. m” represents the remainder from a division of a number by the number m:
m=(mₙ₋₁ . . . m₁m₀)_{b}); where n is the number of words in the representation of numbers m, x, and y, e.g. of 32-bit words;
x=(xₙ₋₁ . . . x₁x₀)_{b});
y=(yₙ₋₁ . . . y₁y₀)_{b});
(0≦x, y<m);
R=bⁿ; or
HCD (m, b)=1; where HCD is the highest common divisor; and
M=−m⁻¹ mod b; where b is the base of the word; where the choices of a known standard for b are 2³² for word sizes at 4 bytes and n=32 for numbers m, x, and y of 1024 bits. n represents the number of bits on which a CPU performs processing.

The Montgomery modular algorithm then proceeds as follows:

1. A←0 (notation A=(aₙaₙ₋₁ . . . a₁a₀)_{b}); where the sign “←” known to the person skilled in the art corresponds to assignment of the value of the computation or of the data item on the right of the sign to the left of the sign;

2. for i in the range 0 to (n−1) do:

(a) uᵢ←(a₀+xᵢ y₀) M mod b;

(b) A←(A+xᵢ y+uᵢ m)/b;

3. If A≧m then A←A−m; and

4. Return of A.

At the output of the Montgomery modular multiplication algorithm, the following result is obtained:

A=xyR⁻¹ mod m.

In the invention, the data items that are to perform the Montgomery modular multiplication perform in parallel the following integrity function applied to a data item x: f(x)=x mod(b−1); such a function also represents the sum of all of the words in the representation of x modulo (b−1), i.e.:

$$f ( x ) = {\sum }_{i = 0}^{i = k} {x}_{i} mod ( b - 1 ) ,$$

where x=(xₖ . . . x₁x₀)_{b}).

The inputs m, x, and y are subjected in parallel to the integrity function:
m′=m mod(b−1);
x′=x mod(b−1); and
y′=y mod(b−1).

Such an integrity function is homomorphous modulo (b−1), i.e. f(x+y)=f(x=+f(y)mod(b−1); and f(x*y)=f(x)*f(y)mod(b−1)

When a data word is modified, the modification is thus detected. When more than one word is modified, the modification is detected with a probability of:

1−(1/(b−1).

Since the data words are summed, the latest modification presents a probability of (1/(b−1)) of being the inverse of all of the modifications that have already been taken into account.

Other than during one or more fault attacks, the integrity verification fails in a single case only: when the two results obtained in parallel, namely the data resulting from the Montgomery modular multiplication and the data resulting from the integrity function, are reinitialized to the initial values, i.e. when all of the bytes are reset to the value “0x00”. However the zero data item then conveys no significant information, in particular as seen by an attacker.

The Montgomery modular algorithm as modified in accordance with the invention then proceeds as follows:

1. A←0 (notation A=(aₙaₙ₋₁ . . . a₁a₀)_{b.})

2. A′←0 (notation A′=(a′₀)_{b.});

3. For i in the range 0 to (n−1) do:

(a) uᵢ←(a₀+xᵢy₀) M mod b;

(b) A←(A+xᵢy+uᵢm)/b;

(c) A′←A+uᵢm′)mod(b−1);

4. A′←(A′+x′y′ mod(b−1);

5. If A≧m then A←A−m; A′←(A′−m′ mod(b−1);

6. Return of A and A′.

At the end of the Montgomery modular multiplication operation and of the integrity function that are executed simultaneously, the following results are respectively obtained:

A=xyR⁻¹ mod m and A′.

The verification of the integrity function where f(A) corresponds to A′ is then still verifiable. Thus, if the correspondence of f(A) and A′ is verified, then no fault attack is taking place or has taken place. Conversely, if the correspondence of f(A) and A′ is not verified, then one or more fault attacks are taking place or have taken place on the electronic circuit.

It should be noted that processing the digital data items X associated with the integrity data items Y, in general, of the hardware word Z, can be reading from and/or writing in a memory, manipulation in a processor unit, transfer of the hardware word Z via a bus specific to the resources of the electronic circuit.

It should be noted that the correspondence between the present notation and the notation used, in generic manner, previously, is as follows:

X₁=X; X₂=y; another operand not yet introduced X₃=m; OP is the Montgomery modular multiplication operation; Y₁=x′; Y₂=y′; and Y₃=m′; A=X and A′=Y.

It can be understood that any computation, in particular within a Rivest-Shamir-Adleman (RSA) cryptographic computation (not shown) involving at least one Montgomery modular multiplication of data can, at any time, during and/or after the Montgomery modular multiplication operation, be the subject of the verification of the integrity function Y=f (X), where X is the subject of the Montgomery modular multiplication operation.

Such an RSA computation is performed, for example, with the purpose of accelerating the hardware implementation of the RSA cryptography computation.

An operation OP is chosen identical to OP′, e.g. an arithmetic addition. The choice of the integrity function f cannot then be free. It is conditioned by f(X₁ OP X₂)=f(X₁) OP f(X₂).

For example, if OP is an arithmetic addition, it is possible to choose f(X)=|X/8|: if X is a value on 8 bits, Y is a value on 5 bits (thus Z is on 13 bits). In general, it is possible to choose, as an example of the function f: f (X)=X/l_{X} where l_{X} is the number of bits (length) of the word X.

In such an implementation, the operations on the software words Xᵢ and on the integrity data Yᵢ are performed in parallel. Thus, the final circuit is as fast as in a version in which the data items are not protected by integrity information. Conversely, the hardware implementation of the ALU 21 (like all of the hardware elements) requires a larger quantity of silicon (proportional to the ratio between X and Y) for equivalent performance.

With reference to FIG. 4, another embodiment of the ALU 21 is proposed. The integrity of the data Z₁ and Z₂ at the input is verified by two check units 13. Only the software words X₁ and X₂ are used for computing X by the operation OP. Then the integrity data items Y are computed by applying the function f to the resulting software word X. The ALU 21 then delivers a complete hardware word X|Y. A set of hardware gates can make it possible to apply the function f to the software word in order to compute the integrity information.

This embodiment is less secure because the integrity data items at the output are recomputed on the basis of the software word X resulting from the operation. There are therefore no means of detecting any error during the operation OP.

The CPU (not shown in FIG. 1) operates on the same principle as the ALU 21. The registers managed by the CPU, and the data items received by the CPU or delivered by the CPU are suitable for machine words of size 1X+1Y. the operations and instructions are performed by the CPU either transparently in order to guarantee high protection for the software data, or by recomputing the integrity data at the end of the processing.

1. A method of processing at least one digital data item X of a software word that is coded on a number l_{X} of bits contained within the software word for detecting at least one fault in an electronic circuit, said electronic circuit comprising hardware resources, the hardware resources comprising at least a bus, a processor unit, and a memory for executing a software program;
said method comprising the following steps:
transforming said at least one digital data item X into digital data items of at least one hardware word Z that are coded on a total number of l_{X}+l_{Y} bits, the total number corresponding to a sum of the number l_{X} of bits contained within the software word and of a number l_{Y} of additional bits of integrity data items Y, the l_{Y} additional bits being the result of an integrity function f applied to said at least one digital data item X;
processing the digital data items of said at least one hardware word Z by the entire set of the hardware resources of the electronic circuit, the hardware resources working on at least one hardware word Z of the total number of l_{X}+l_{Y} bits; and
verifying the integrity of said digital data items of said at least one hardware word Z during and/or after said processing step.

2. A method according to claim 1, wherein said digital data of said at least one hardware word Z comprises the concatenation of said at least one digital data item X with the integrity data Y resulting from the integrity function f applied to said at least one digital data item X.

3. A method according to claim 1, wherein; said processing step is performed by an arithmetic and logic unit, and comprises:
a first computation step for computing an operation OP on said at least one digital data item X of the digital data items of said at least one hardware word Z; and
a second computation step for computing said operation OP on the additional integrity bits of said digital data of said at least one hardware word Z, said integrity function f complying with the following formula:
f(X₁OPX₂)=f(X₁)OPf(X₂);
the first and second computation steps being performed simultaneously.

4. A method according to claim 1, wherein
said processing step is performed by an arithmetic and logic unit, and comprises:
a first step for checking the integrity of the digital data items of said at least one hardware word Z;
a following step for computing an operation OP on said at least one digital data item X of the digital data items of said at least one hardware word Z; and
a step for transforming the digital data items resulting from said operation OP into digital data items Z′ coded on a total number of l_{X}+l_{Y} bits, the total number corresponding to a sum of the number l_{X} of bits contained within the software word and of an additional number of l_{Y} of additional bits, the l_{Y} additional bits being the result of the integrity function f applied to said data items resulting from said operation OP.

5. A method according to;
claim 1, wherein said function f is defined by f(X)=X/l_{X}, where:
l_{X} is the length in number of bits of the binary word X; and
the sign “/” is a division operation.

6. A hardware architecture for detecting at least one fault in an electronic circuit, the hardware architecture comprising:
transformation means for transforming at least one digital data item X of a software word that is coded on a number l_{X} of bits contained within the software word into digital data items of at least one hardware word Z that are coded on a total number of l_{X}+l_{Y} bits, the total number corresponding to a sum of the number l_{X} of bits contained within the software word and of an additional number l_{Y} of additional bits of integrity data items Y, the l_{Y} additional bits being the result of an integrity function f applied to said at least one digital data item X;
hardware resources comprising at least a bus, a processor unit, and a memory, for performing at least one processing step for processing the digital data items of said at least one hardware word Z, the entire set of the hardware resources of the electronic circuit working on at least one hardware word Z of the total number of l_{X}+l_{Y} bits; and
means for verifying the integrity of said digital data items of said at least one hardware word Z during and/or after said processing step.

7. An architecture according to claim 6, wherein said hardware resources comprise at least registers associated with a central processing unit, said registers storing the digital data of said at least one hardware word Z in the form of words of size l_{X}+l_{Y} bits, and said central processing unit comprising means operating on said at least one digital data item X and the integrity data items Y.

8. An architecture according to claim 6,
wherein said hardware resources comprise at least one arithmetic and logic unit computing an operation OP separately on said at least one digital data item X and on the additional integrity bits Y of the digital data of at least one hardware word Z, and wherein said integrity function f complies with the following:
f(X₁OPX₂)=f(X₁)OPf(X₂).

9. An architecture according to claim 6,
wherein said material resources comprise at least one arithmetic and logic unit, said arithmetic and logic unit;
comprising means for checking the integrity of said digital data items of said at least one hardware word Z;
computing an operation OP on said at least one digital data item X of the digital data items of said at least one hardware word Z; and
transforming the digital data items resulting from said operation OP into digital data items Z′ coded on a total number of l_{X}+l_{Y} bits, the l_{Y} additional bits being the result of the integrity function f applied to said data items resulting from said operation OP.

10. A smart card including a hardware architecture according to claim 6.
